(19) United States
(12) Patent Application Publication
(10) Pub. No.: US 2026/0177522 A1
(43) Pub. Date: Jun. 25, 2026

(54) SENSOR ELEMENT, GAS SENSOR, AND SENSOR ELEMENT MANUFACTURING METHOD

(71) Applicant: Niterra Co., Ltd., Nagoya-shi, Aichi (JP)

(72) Inventors: Kazuma ITO, Nagoya-shi, Aichi (JP); Wakako NANYA, Nagoya-shi, Aichi (JP)

(73) Assignee: Niterra Co., Ltd., Nagoya-shi, Aichi (JP)

(21) Appl. No.: 19/127,270

(22) PCT Filed: Aug. 22, 2023
(86) PCT No.: PCT/JP2023/030112

§ 371 Date: May 5, 2025

(30) Foreign Application Priority Data
Nov. 8, 2022 (JP) 2022-178657

(51) Int. Cl. G01N 27/407; G01N 27/30

(52) U.S. Cl. CPC G01N 27/4077; G01N 27/301; G01N 27/4073

(57) ABSTRACT

A sensor element including an oxygen-ion conductive solid electrolyte body, a detection electrode provided on a surface of the electrolyte body and in contact with a measured gas, and a reference electrode provided on the other surface of the electrolyte body and in contact with a reference gas; a catalyst layer covering the detection electrode and including a porous carrier of ceramic particles, and catalyst particles supported on the carrier and formed of a noble metal (Pt, Pd, Rh, and/or Au). The carrier includes oxide particles bonded to portions of surfaces of the ceramic particles, the oxide particles having a composition different from the ceramic particles, being smaller than the ceramic particles, and being formed of zirconia, alumina, or lanthana. The catalyst particles are supported on either of surfaces of the oxide particles and the surfaces of the ceramic particles.

### TECHNICAL FIELD

The present invention relates to a sensor element used in a gas sensor which is preferably used for detection of the concentration of a particular gas contained in, for example, combustion gas or exhaust gas discharged from a combustor, an internal combustion engine, or the like, to the gas sensor, and to a method for manufacturing the sensor element.

### BACKGROUND ART

As a gas sensor for detecting the concentration of oxygen in exhaust gas discharged from an automobile or the like, there has been known a gas sensor which includes a sensor element in which a detection electrode and a reference electrode are provided on the surface of a tubular or plate-shaped solid electrolyte. In addition, a porous electrode protection layer for preventing poisoning of the detection electrode is formed on the surface of the detection electrode.

Moreover, there has been developed a technique for enhancing gas detection accuracy and response or stabilizing sensor output by forming the porous electrode protection layer such that catalyst particles formed of a noble metal (e.g., Pt) are supported by the electrode protection layer and causing a particular component of exhaust gas having passed through the porous protection layer to react with the catalyst particles (Patent Literatures 1 and 2).

### CITATION LIST

### Patent Literatures

Patent Literature 1: JP 2002-71632A

Patent Literature 2: JP2019-117135A

### SUMMARY OF INVENTION

### Technical Problem

However, there has been a problem that, due to heat and atmosphere in exhaust gas during use of the gas sensor, the catalyst particles within the porous protection layer aggregate, resulting in coarsening, which decreases the surface area of the catalyst and lowers catalytic performance.

In view of this, an object of the present invention is to provide a sensor element which suppresses lowering of the catalytic performance of a catalyst supported on a porous carrier, a gas sensor containing the sensor element, and a method for manufacturing the sensor element.

### Solution To Problem

In order to solve the above-described problem, a sensor element of the present invention comprises an oxygen-ion conductive solid electrolyte body, a detection electrode which is provided on one surface of the solid electrolyte body and comes into contact with a gas to be measured, and a reference electrode which is provided on the other surface of the solid electrolyte body and comes into contact with a reference gas. The sensor element is characterized by further comprising a catalyst layer which covers the detection electrode, the catalyst layer including a porous carrier formed of ceramic particles, and catalyst particles supported on the carrier and formed of one or more noble metals selected from a group consisting of Pt, Pd, Rh, and Au. The carrier includes oxide particles bonded to portions of surfaces of the ceramic particles, the oxide particles having a composition different from that of the ceramic particles, being smaller than the ceramic particles in terms of circle-equivalent diameter in a cross-sectional image, and being formed of zirconia, alumina, or lanthana. The catalyst particles are supported on at least either of surfaces of the oxide particles and the surfaces of the ceramic particles.

In this sensor element, since the carrier of the catalyst layer has a structure in which small oxide particles are bonded to portions of the surfaces of the ceramic particles, it is possible to prevent the catalyst particles from aggregating, resulting in coarsening, which would otherwise occur due to heat and atmosphere in exhaust gas during use of the gas sensor. As a result, it is possible to prevent decreasing of the surface area of the catalyst particles and lowering of catalytic performance.

Although the reason for these effects is not clear, it is assumed that, since the oxide particles formed of zirconia, alumina, or lanthana are bonded to the ceramic particles, the surface states (electric potential, etc.) of the ceramic particles and the oxide particles change and the catalyst particles are bonded more strongly to the ceramic particles and the oxide particles.

A gas sensor of the present invention comprises a sensor element and a shell body which holds the sensor element, characterized in that the sensor element is the sensor element as recited in claim 1.

A sensor element manufacturing method of a first mode of the present invention is a method for manufacturing the sensor element as recited in claim 1, characterized in that the carrier is manufactured by applying a slurry to cover the detection electrode and firing the slurry, the slurry containing the ceramic particles and ions of zirconia, alumina, or lanthana for depositing the oxide particles.

A sensor element manufacturing method of a second mode of the present invention is a method for manufacturing the sensor element as recited in claim 1, characterized in that a porous body which is to serve as the carrier is manufactured by applying a slurry containing the ceramic particles to cover the detection electrode and firing the slurry, and the porous body is impregnated with a solution containing ions of zirconia, alumina, or lanthana for depositing the oxide particles and is fired.

### Advantageous Effect Of Invention

According to this invention, a sensor element which suppresses lowering of the catalytic performance of a catalyst supported on a porous carrier can be obtained.

### BRIEF DESCRIPTION OF DRAWINGS

FIG. 1 Cross-sectional view of a gas sensor (oxygen sensor) according to an embodiment of the present invention, the cross-sectional view being taken in the longitudinal direction of the gas sensor

FIG. 2 Schematic exploded perspective view of a sensor element.

FIG. 3 Enlarged cross-sectional view of a portion of the sensor element on its forward end side.

FIG. 4 Schematic cross-sectional view of the sensor element taken perpendicular to its axial direction.

FIG. 5 Schematic cross-sectional view of a catalyst layer.

FIG. 6 Schematic view showing a method for measuring the particle size of a ceramic particle.

FIG. 7 Photograph showing a cross-sectional SEM image of the catalyst layer

FIG. 8 Photograph showing, on an enlarged scale, the cross-sectional SEM image of the catalyst layer.

FIG. 9 Graph showing results of evaluation of gas sensitivity

FIG. 10 Photograph showing a cross-sectional SEM image of a catalyst particle (Pt particle) grew in the catalyst layer of Example and Comparative Example.

FIG. 11 Photograph showing a cross-sectional SEM image of a catalyst particle (Pt particle) grew in the catalyst layer of Comparative Example.

### DESCRIPTION OF EMBODIMENT

An embodiment of the present invention will now be described.

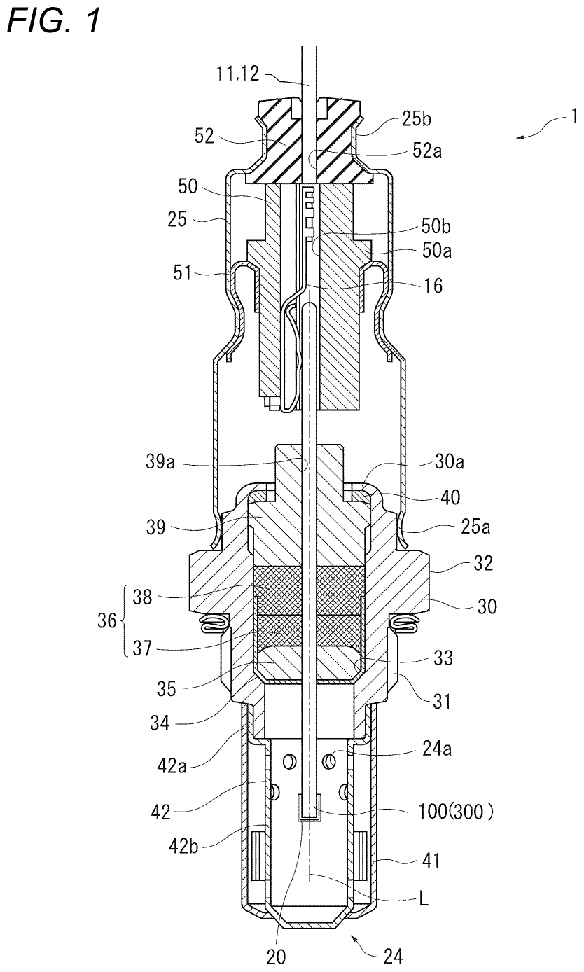

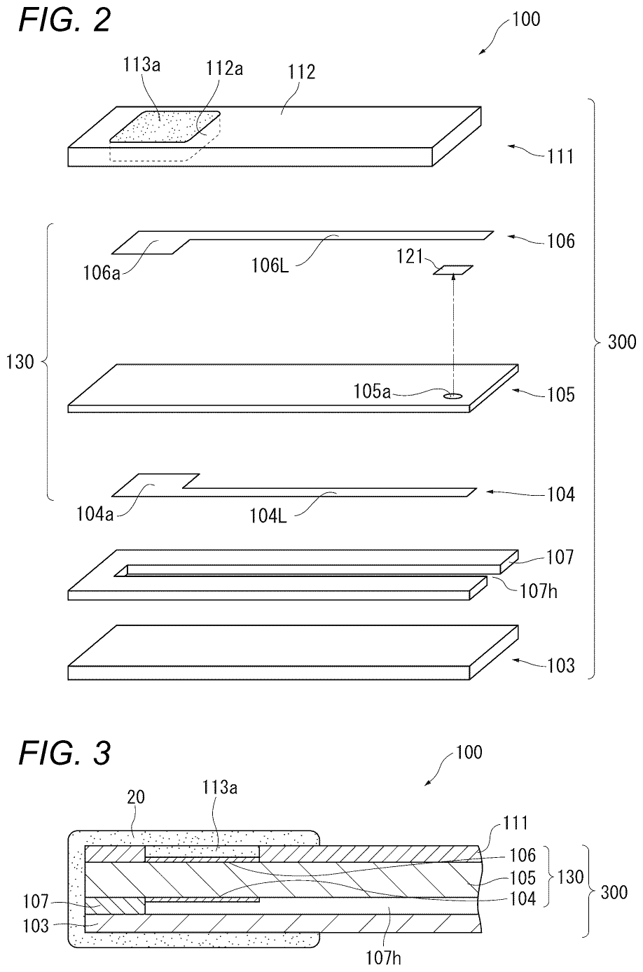

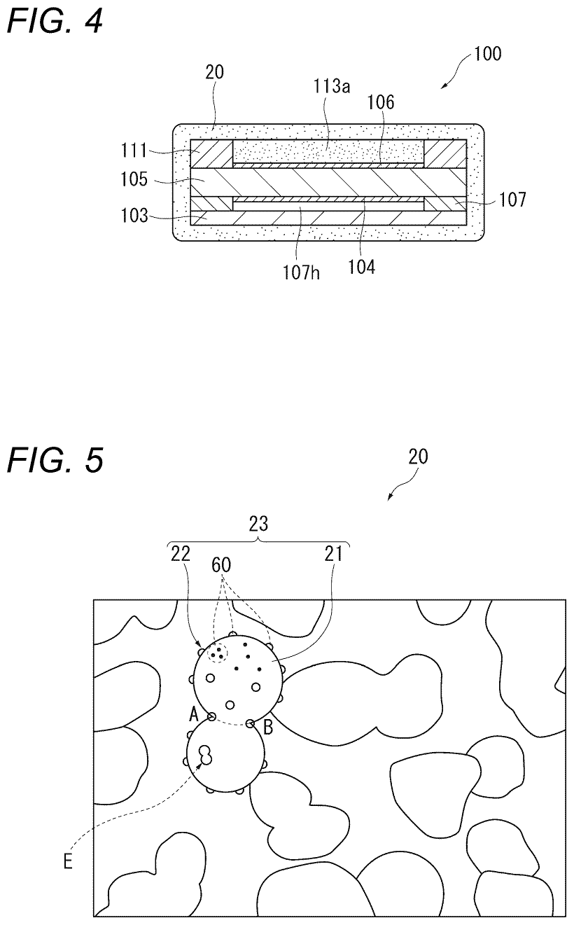

FIG. 1 is a cross-sectional view of a gas sensor (oxygen sensor) 1 according to an embodiment of the present invention, the cross-sectional view being taken in the longitudinal direction (the direction of an axial line L) of the gas sensor 1. FIG. 2 is a schematic exploded perspective view of a sensor element 100. FIG. 3 is an enlarged cross-sectional view of a portion of the sensor element 100 on its forward end side. FIG. 4 is a schematic cross-sectional view of the sensor element 100 taken perpendicular to the direction of the axial line L.

As shown in FIG. 1, the gas sensor 1 includes the sensor element 100, a shell body (metallic shell) 30 which holds the sensor element 100, etc. therein, a protector 24 attached to a forward end portion of the shell body 30, etc. The sensor element 100 is disposed to extend in the direction of the axial line L.

Also, a catalyst layer 20 is provided on the forward end side of the sensor element 100 so as to cover a detection electrode (see FIG. 2).

As shown in FIG. 2, the sensor element 100 includes an oxygen concentration detection cell 130 composed of a solid electrolyte body 105 and a reference electrode 104 and a detection electrode 106 formed on opposite sides of the solid electrolyte 105. The reference electrode 104 has a reference electrode portion 104a and a reference lead portion 104L extending from the reference electrode portion 104a along the longitudinal direction of the solid electrolyte body 105. The detection electrode 106 has a detection electrode portion 106a and a detection lead portion 106L extending from the detection electrode portion 106a along the longitudinal direction of the solid electrolyte body 105.

Notably, in FIG. 2, the catalyst layer 20 is not shown.

A protection layer 111 has a porous electrode protection portion 113a and a reinforcement portion 112. The electrode protection portion 113a prevents poisoning of the detection electrode portion 106a by sandwiching the detection electrode portion 106a between the electrode protection portion 113a and the solid electrolyte body 105. The reinforcement portion 112 protects the solid electrolyte body 105 while sandwiching the detection lead portion 106L between the reinforcement portion 112 and the solid electrolyte body 105. Notably, the sensor element 100 of the present embodiment constitutes a so-called oxygen concentration electromotive force-type gas sensor (λ sensor) which can detect the concentration of oxygen by using the voltage (electromotive force) produced between the electrodes of the oxygen concentration detection cell 13.

Meanwhile, a lower surface layer 103 and an atmosphere introduction hole layer 107 are stacked on a lower surface of the reference electrode 104 such that the reference electrode 104 is sandwiched between the solid electrolyte body 105 and the lower surface layer 103 and the atmosphere introduction bole layer 107. The atmosphere introduction hole layer 107 has a generally squarish C-like shape with an opening on its rear end side. An internal space surrounded by the solid electrolyte body 105, the atmosphere introduction hole layer 107, and the lower surface layer 103 constitutes an atmosphere introduction hole 107h The reference electrode 104 is exposed to the atmosphere (reference gas) introduced to this atmosphere introduction hole 107h.

A stack of the lower surface layer 103, the atmosphere introduction hole layer 107, the reference electrode 104, the solid electrolyte body 105, the detection electrode 106, and the protection layer 111 constitutes an element body 300. In the present embodiment, the element body 300 has a plate-like shape.

An end of the reference lead portion 104L is electrically connected to a detection-element-side pad 121 on the solid electrolyte body 105 via a conductor formed in a through hole 105a provided in the solid electrolyte body 105. Meanwhile, the protection layer 111 is shorter in the direction of the axial line L than the end of the detection lead portion 106L, so that the end of the detection lead portion 106L projects from the rear end of the protection layer 111 and appears on the upper surface. The end of the detection lead portion 106L is connected to an external terminal (not shown) for connection of an external circuit.

Notably, the solid electrolyte body 105 has oxygen ion conductivity and may contain, as a main component, for example, a partially stabilized zirconia (YSZ) solid solution prepared by adding yttria as a stabilizer. Herein, the main component refers to a component whose amount is greater than 50 mass % of the solid electrolyte body 3s.

Each of the reference electrode 104 and the detection electrode 106 is formed mainly of Pt, for example. Herein, the expression “mainly of Pt” shows that “the component whose amount is greater than 50 mass % of the electrode is Pt.

Each of the lower surface layer 103, the protection layer 111, and the atmosphere introduction hole layer 107 may be formed of an insulating material such as alumina. The electrode protection portion 113a may be a porous body formed mainly of zirconia. The porous body can be formed, for example, by bonding, through firing or the like, particles of one or more ceramic materials selected from the group consisting of alumina, spinel, zirconia, mullite, zircon, and cordierite. When a slurry containing these particles is fired, an organic or inorganic binder present in the gaps between the ceramic particles and in the slurry burns and disappears, whereby pores are formed in the skeleton of the layer.

Returning to FIG. 1, the shell body 30 is formed of SUS430 and has a male screw portion 31 for attaching the gas sensor to an exhaust pipe and a hexagonal portion 32 with which an attachment tool is engaged when the gas sensor is attached to the exhaust pipe. The shell body 30 has a shell-side step portion 33 protruding radially inward, and the shell-side step portion 33 supports a metallic holder 34 used to hold the sensor element 100.

A ceramic holder 35 and talc 36 are disposed inside the metallic holder 34 in this order from the forward end side. The tale 36 is composed of first tale 37 disposed inside the metallic holder 34 and second tale 38 disposed across the rear end of the metallic holder 34.

The first tale 37 is compressed and packed inside the metallic holder 34, and the sensor element 100 is thereby fixed to the metallic holder 34. The second tale 38 is compressed and packed inside the shell body 30, thereby providing a seal between the outer surface of the sensor element 100 and the inner surface of the shell body 30.

A sleeve 39 formed of alumina is disposed on the rear end side of the second talc 38. This sleeve 39 is formed into a stepped cylindrical shape and has an axial hole 39a extending along the axial line, and the sensor element 100 is inserted into the axial hole 39a. A crimp portion 30a on the rear end side of the shell body 30 is bent inward, so that the sleeve 39 is pressed toward the forward end side of the shell body 30 via a ring member 40 formed of stainless steel.

The protector 24 which is formed of a metal and has a plurality of gas introduction holes 24a is attached, by means of welding, to the outer circumference of a forward end portion of the shell body 30 so as to cover a forward end portion of the sensor element 100 protruding from the forward end of the shell body 30. This protector 24 has a double structure including a closed-end cylindrical outer protector 41 disposed on the outer side and having a uniform outer diameter, and a closed-end cylindrical inner protector 42 disposed on the inner side and formed such that its rear end portion 42a has an outer diameter larger than that of its forward end portion 42b.

A forward end portion of an outer tube 25 formed of SUS430 is fitted into a rear end portion of the shell body 30. A forward end portion 25a of the outer tube 25, which portion is increased in diameter on the forward end side, is fixed to the shell body 30 by means of, for example, laser welding. A separator 50 is disposed inside a rear end portion of the outer tube 25, and a holding member 51 is provided in the gap between the separator 50 and the outer tube 25. This holding member 51 engages with a protruding portion 50a, described later, of the separator 50. When the outer tube 25 is crimped, the holding member 51 is fixed by the outer tube 25 and the separator 50.

An insertion hole 50b into which lead wires 11 and 12 (in FIG. 1, the lead wire 12 is not illustrated because it is hidden behind the lead wire 11) for the sensor element 100 are inserted is formed in the separator 50 so as to extend therethrough from the forward end to the rear end. Connection terminals 16 for connecting the lead wires 11 and 12 to the detection element-side pads 121 of the sensor element 100 are accommodated in the insertion hole 50b. The lead wires 11 and 12 are connected to an unillustrated connector externally. Electric signals are transferred (for input and output of the electric signals) between the lead wires 11 and 12 and an external device such as an ECU through the connector. Although not illustrated in detail, each of the lead wires Il and 12 has a structure in which a conducting wire is covered with an insulating resin coating.

An approximately cylindrical rubber cap 52 is disposed on the rear end side of the separator 50 so as to close a rear-end-side opening 25b of the outer tube 25. This rubber cap 52 is inserted into the rear end of the outer tube 25 and fixed to the outer tube 25 by crimping the outer circumference of the outer tube 25 radially inward. Insertion holes 52a into which the lead wires 11 to 15 are inserted are formed in the rubber cap 52 so as to extend therethrough from the forward end to the rear end.

Next, the catalyst layer 20 will be described. As shown in FIGS. 3 and 4, the catalyst layer 20 is a porous layer provided to cover the entire circumference of a forward end portion of the sensor element 100 (the element body 300).

The catalyst layer 20 is formed to contain a forward end surface of the sensor element 100 (the element body 300) and extend along the direction of the axial line L toward the rear end side. As shown in FIG. 4, the catalyst layer 20 is formed to completely surround the four surfaces (i.e., front and back surfaces and opposite side surfaces) of the sensor element 100 (the element body 300). As viewed in the direction of the axial line L, the catalyst layer 20 covers at least a region of the sensor element 100 (the element body 300) which contains the reference electrode portion 104a and the detection electrode portion 106a (this region constitutes a detection portion) and extends from this region to the rear end.

The sensor element 100 may be exposed to a poisoning substance such as silicon and phosphorous contained in exhaust gas, and water droplets in the exhaust gas may adhere to the sensor element 100. Since the outer surface of the sensor element 100 is covered with the catalyst layer 20, it is possible to capture the poisoning substance and prevent water droplets from coming into direct contact with the sensor element 100.

As shown in FIG. 5, the catalyst layer 20 includes a porous carrier 23 formed of ceramic particles, and catalyst particles 60 supported on the carrier 23 and formed of one or more noble metals selected from the group consisting of Pt, Pd, Rh, and Au.

The catalyst particles 60 can enhance gas detection accuracy and response and stabilize the sensor output by reacting with a particular component of exhaust gas having passed through the catalyst layer 20 (burning an unburned gas component). For example, the catalyst particles 60 can enhance the response of the gas sensor in an environment in which the gas flow speed is high.

This will be described briefly. When the gas flow speed becomes high, the unburned gas fail to burn sufficiently on the detection electrode 106 and remains in the catalyst layer 20. While the electrode reaction proceeds toward the equilibrium state, for example, CO gas (one type of the unburned gas) remaining in the catalyst layer 20 reaches the detection electrode 106 and reacts therewith. In this case, the sensor output may fail to reflect the actual gas concentration.

In order to solve such a problem, the catalyst particles 60 are caused to be incorporated into the catalyst layer 20. Since a portion of the unburned gas reacts with the catalyst particles 60 and burns in the catalyst layer 20, it is possible to enhance the response of the gas sensor in an environment in which the gas flow speed is high.

Needless to say, the effect attained by incorporating the catalyst particles 60 into the catalyst layer 20 is not limited thereto.

Incidentally, due to heat and atmosphere in exhaust gas during use of the gas sensor 1, the catalyst particles 60 within the catalyst layer 20 aggregate, resulting in coarsening, which decreases the surface area of the catalyst and lowers the catalytic performance.

In view of this, the present invention has realized suppression of lowering of the catalytic performance of the catalyst particles 60 supported on the carrier 23 by configuring the carrier 23 as follows.

Namely, as shown in FIG. 5, the carrier 23 has a structure in which oxide particles 22 having a composition different from that of the ceramic particles 21 and being smaller in size than the ceramic particles 21 are bonded to portions of the surfaces of the ceramic particles 21. Thus, a portion of the surface of each ceramic particle 21 is exposed, and the remaining portion of the surface is covered by the oxide particles 22.

The catalyst particles 60 are formed in a scattered manner on at least either of the surfaces of the oxide particles 22 and the surfaces of the ceramic particles 21 constituting the carrier 23.

The ceramic particles 21 preferably contain at least one or more species selected from, for example, alumina, alumina magnesia spinel, zirconia, and titania, and an example of a preferred ceramic material is alumina magnesia spinel.

The oxide particles 22 are formed of zirconia, alumina, or lanthana. Although zirconia has a composition of, for example, ZrO₂, it may contain a non-stoichiometric compound of Zr and oxygen, etc.

In the case where the carrier 23 has a structure in which the small oxide particles 22 are bonded to portions of the surfaces of the ceramic particles 21, it is possible to prevent the catalyst particles 60 from aggregating, resulting in coarsening, which would otherwise occur due to heat and atmosphere in exhaust gas during use of the gas sensor. As a result, it is possible to prevent decreasing of the surface area of the catalyst particles 60 and lowering of the catalytic performance.

Although the reason for these effects is not clear, it is assumed that, since the oxide particles 22 formed of zirconia, alumina, or lanthana are bonded to the ceramic particles 21, the surface states (electric potential, etc.) of the ceramic particles 21 and the oxide particles 22 change and the catalyst particles 60 are bonded more strongly to the ceramic particles 21 and the oxide particles 22.

The ceramic particles 21 and the oxide particles 22 can be differentiated from each other by performing elemental analysis of a cross-sectional sample of the catalyst layer 20 with an EPMA (electron beam microanalyzer) or EDS (energy dispersive X-ray spectrometry).

The particle sizes of the ceramic particles 21 and the oxide particles 22 are determined by obtaining the individual circle-equivalent diameters of the ceramic particles 21 and the oxide particles 22 identified by elemental analysis in the cross-sectional sample of the catalyst layer 20 (the above-described EPMA image, EDS image, etc.).

Comparison between the particle sizes of the ceramic particles 21 and the oxide particles 22 is performed for the oxide particles 22 bonded to the surfaces of three or more ceramic particles 21 in the cross-sectional sample. In the case where, as indicated by E in FIG. 5, a first oxide particle 22 is bonded to the surface of a ceramic particle 21 and a second oxide particle 22 is bonded to the surface of the first oxide particle 22 (without intervention of the ceramic particle 21), the second oxide particle 22 is excluded.

In some cases, as shown in FIG. 5, individual ceramic particles 21 are bonded and united as a result of sintering, whereby the boundary A-B therebetween becomes unclear.

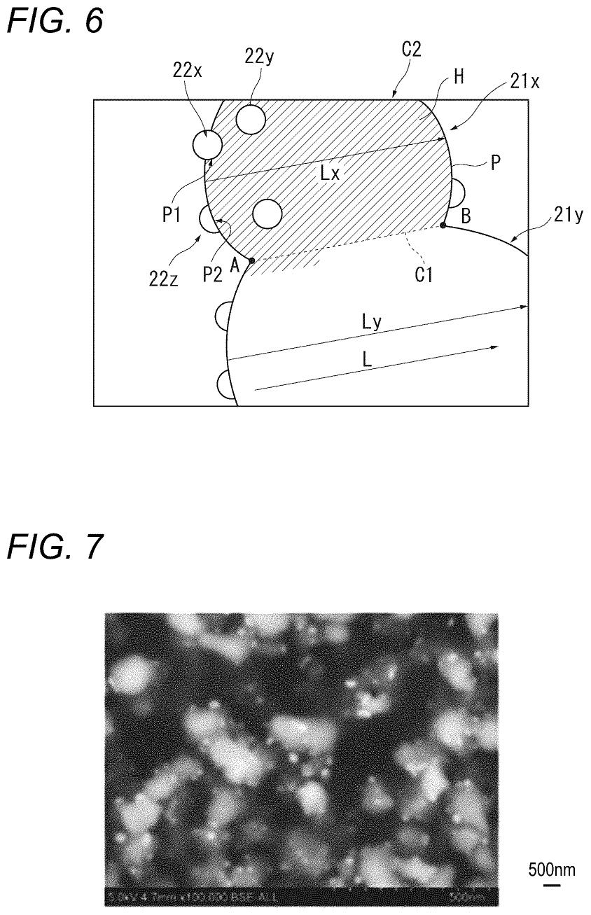

In view of this, in the case where, as shown in FIG. 6, a ceramic particle 21x and a ceramic particles 21y located adjacent thereto are considered to have been bonded as a result of sintering, the boundary therebetween is determined as follows.

First, in the case where the contour P of the ceramic particle 21x shows that the ceramic particle 21x becomes narrow and forms a neck portion between points A and B, a direction parallel to a straight line C1 connecting the points A and B is defined as the direction L. Here, in the contours of the ceramic particle 21x and the ceramic particle 21y bonded to each other, the lengths of longest lines parallel to the direction L are represented by Lx and Ly, respectively. In the case where the length of the straight line C1 is smaller than both the lengths Lx and Ly, the two ceramic particles 21x and 21y are considered to have been bonded as a result of sintering in the region between the points A and B, and the straight line C1 is considered as the boundary between the two ceramic particles 21x and 21y.

In the case where a portion of the ceramic particle 21x is located outside the above-described field of view, the outer edge C2 of the field of view is employed as a portion of the contour P of the ceramic particle 21x.

In the case where the outermost contour P of the ceramic particle 21x overlaps with oxide particles 22x and 22z, the contours P1 and P2 of the boundaries between the ceramic particle 21x and the oxide particles 22x and 22z are employed as portions of the contour P of the ceramic particle 21x. Meanwhile, oxide particles 22y present within the contour P of the ceramic particle 21x are ignored.

Accordingly, the straight lines C1 and C2 are considered as portions of the contour P of the ceramic particle 21x, and the area surrounded by the entire contour P (a hatched portion of FIG. 6) is considered as the circle-equivalent diameter of the ceramic particle 21x.

Next, a sensor element manufacturing method according to the embodiment of the present invention will be described. In this sensor element manufacturing method, the carrier 23 of the catalyst layer 20 is formed as follows. A slurry containing the ceramic particles 21 and ions of zirconia, alumina, or lanthana, which become the oxide particles 22, is applied to the surface of a forward end portion of the sensor element 100 to cover the detection electrode 106 (the detection electrode portion 106a) and fired.

Ions which become the oxide particles are contained in, for example, an aqueous solution of oxyacetatozirconium, which is a complex. The slurry can be prepared by mixing this aqueous solution, the ceramic particles 21, a binder, and water or a solvent such as PGA. When this slurry is fired, the oxide particles 22 are formed from the ions through deposition and are bonded to portions of the surfaces of the ceramic particles 21, whereby the carrier 23 is obtained.

In an alternative method, for example, a porous layer formed of the ceramic particles 21 is impregnated with a solution containing Zr ions (e.g., zirconium nitrate solution) and heated. As a result, the oxide particles 22 are deposited on the ceramic particles 21 and are bonded to portions of the surfaces of the ceramic particles 21, whereby the carrier 23 is obtained.

When the carrier 23 obtained through firing is immersed in a solution containing catalyst ions (e.g., dinitrodiammine Pi nitrate solution) and heated, minute catalyst particles 60 are deposited on the surface of the carrier.

The present invention is not limited to the above-described embodiment. The sensor element is only required to include a solid electrolyte body, a detection electrode, and a reference electrode and can be applied to the oxygen sensor (the oxygen sensor element) of the present embodiment. However, needless to say, the present invention is not limited to these applications and encompasses various modifications and equivalents which fall within the idea and range of the present invention.

For example, the present invention may be applied to a full-range oxygen sensor having an oxygen pump cell, an NOx sensor (NOx sensor element) for detecting the concentration of NOx in a gas under measurement, an HC sensor (HC sensor element) for detecting the concentration of HC. The sensor element may be a tubular type, and may be a binary sensor or a linear sensor.

The gas sensor may have a heater which generates heat upon energization.

### EXAMPLE

### Evaluation of Gas Sensitivity

The plate-shaped sensor element (oxygen sensor element) 100 shown in FIGS. 1 and 2 was manufactured.

There was prepared a slurry containing alumina particles (the ceramic particles 21), an aqueous solution of oxyacetatozirconium(complex) including a zirconia ion structure (for deposition of the oxide particles 22), a binder, and water. The prepared slurry was applied to the surface of a forward end portion of the sensor element 100 to cover the detection electrode 106 (the detection electrode portion 106a) and fired. Thus, the carrier 23 of the catalyst layer 20 was obtained. The amount of the oxide particles 22 (zirconia) was set to 5 mass % of the carrier 23.

Furthermore, the carrier 23 obtained through firing was immersed in a solution containing catalyst Pt ions (e.g., dinitrodiammine Pt nitrate solution) and heated. This was used as Example.

As Comparative Example, the carrier 23 of the catalyst layer 20 was formed in the same manner as described above, except that the slurry did not contain the aqueous solution containing ions of zirconia, and the carrier 23 obtained through firing was immersed in a solution containing catalyst Pt ion (e.g., dinitrodiammine Pt nitrate solution) and heated.

Next, the above-described sensor element 100 was incorporated into the gas sensor 1, and gas sensitivity was evaluated on the basis of the difference between sensor outputs for predetermined different two gas compositions (gas in which He was predominant and gas in which CO was predominant). The gas sensitivity refers to the degree of influence of the composition of the gas under measurement on the sensor output for the component to be measured, and the smaller the numerical value, the better the gas sensitivity.

FIG. 7 to 11 show the obtained results.

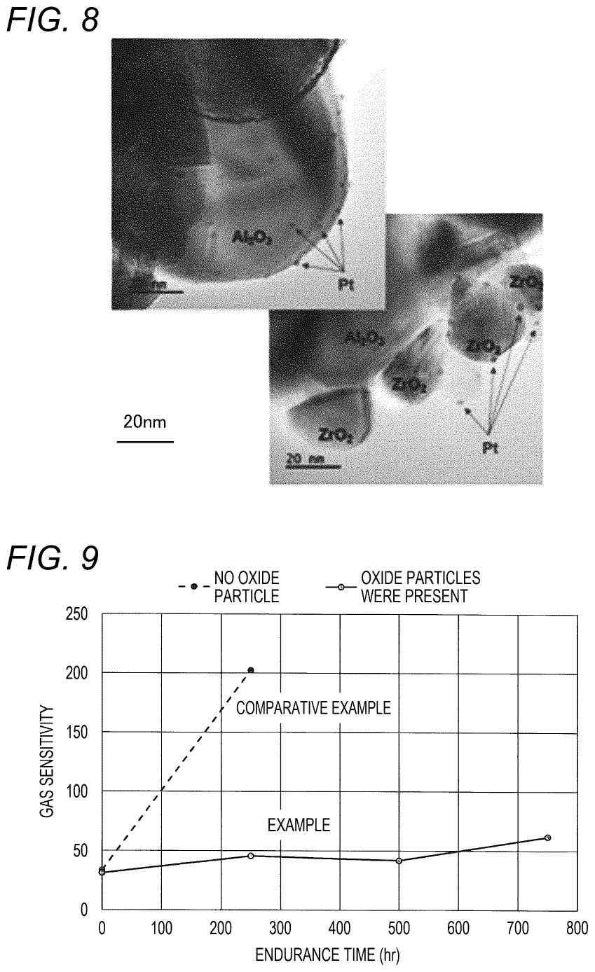

FIGS. 7 and 8 show cross-sectional SEM images of the catalyst layer 20.

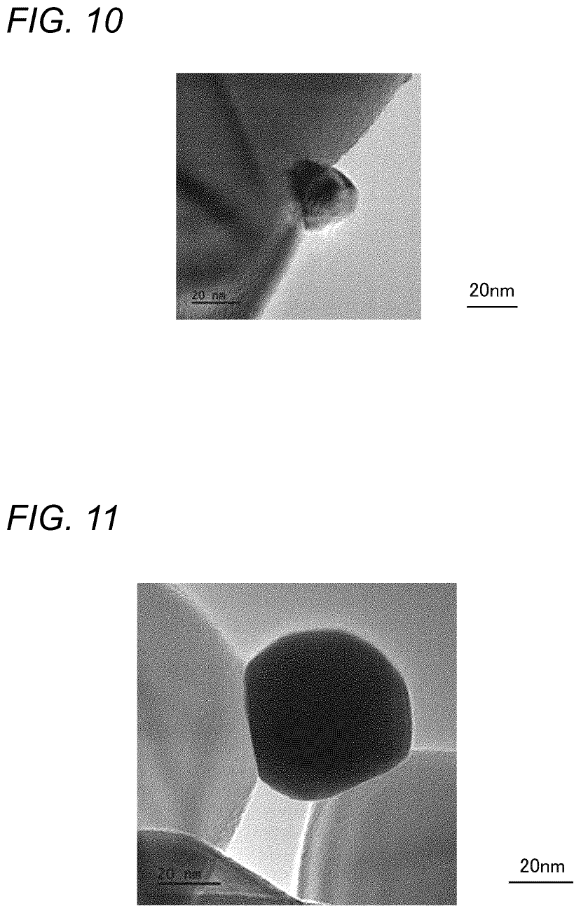

FIG. 9 show the results of evaluation of gas sensitivity, and FIGS. 10 and 11 respectively show cross-sectional SEM images of grew catalyst particles 60 (Pt particles) in the catalyst layer 20 in Example and Comparative Example.

FIGS. 7 and 8 show that small particles of zirconia (the oxide particles 22) were deposited on portions of the surfaces of alumina particles (the ceramic particles 21) and also show that, in the present example, minute Pt particles (catalyst particles 60) were deposited on both the surfaces of the ceramic particles 21 and the surfaces of the oxide particles 22.

As shown in FIG. 9, in the case of Example using the carrier 23 in which small particles of zirconia (the oxide particles 22) were deposited on portions of the surfaces of alumina particles (the ceramic particles 21), gas sensitivity was satisfactory over a long period of time.

Meanwhile, in the case of Example in which only alumina particles (the ceramic particles 21) were used as the carrier 23, gas sensitivity deteriorated with time.

As shown in FIGS. 10 and 11, it was found that, in the case of Example, the particle size of grew Pt particles was about 20 nm at most and that, in the case of Comparative Example, Pt particles grew to about 50 nm.

### REFERENCE SIGNS LIST

1: gas sensor
20: catalyst layer
21: ceramic particle
22: oxide particle
23: carrier
30: shell body
60: catalyst particle
100: sensor element
104: reference electrode
106: detection electrode
105: solid electrolyte body

1. A sensor element comprising: an oxygen-ion conductive solid electrolyte body, a detection electrode which is provided on one surface of the solid electrolyte body and comes into contact with a gas to be measured, and a reference electrode which is provided on the other surface of the solid electrolyte body and comes into contact with a reference gas,
the sensor element being characterized by further comprising a catalyst layer which covers the detection electrode, the catalyst layer including a porous carrier formed of ceramic particles, and catalyst particles supported on the carrier and formed of one or more noble metals selected from a group consisting of Pt, Pd, Rh, and Au,
wherein the carrier includes oxide particles bonded to portions of surfaces of the ceramic particles, the oxide particles having a composition different from that of the ceramic particles, being smaller than the ceramic particles in terms of circle-equivalent diameter in a cross-sectional image, and being formed of zirconia, alumina, or lanthana, and
the catalyst particles are supported on at least either of surfaces of the oxide particles and the surfaces of the ceramic particles.

2. A gas sensor comprising a sensor element and a shell body which holds the sensor element, characterized in that the sensor element is the sensor element as recited in claim 1.

3. A method for manufacturing the sensor element as recited in claim 1, characterized in that the carrier is manufactured by applying a slurry to cover the detection electrode and firing the slurry, the slurry containing the ceramic particles and ions of zirconia, alumina, or lanthana for depositing the oxide particles.

4. A method for manufacturing the sensor element as recited in claim 1, characterized in that a porous body which is to serve as the carrier is manufactured by applying a slurry containing the ceramic particles to cover the detection electrode and firing the slurry, and the porous body is impregnated with a solution containing ions of zirconia, alumina, or lanthana for depositing the oxide particles and is fired.
